(19) United States
(12) Patent Application Publication
(10) Pub. No.: US 2007/0147593 A1
(43) Pub. Date: Jun. 28, 2007

(54) Electronic player for implementing internet telephone functions and method thereof

(75) Inventors: Cheng-Shing Lai, Taipei (TW); Zheng-Rong Zou, Nanking (CN); Feng Zeng, Nanking (CN)

Correspondence Address: BACON & THOMAS, PLLC, 625 SLATERS LANE, FOURTH FLOOR, ALEXANDRIA, VA, 22314, US

(73) Assignee: Inventec Appliances Corp., Taipei (TW)

(21) Appl. No.: 11/645,062

(22) Filed: Dec. 26, 2006

(30) Foreign Application Priority Data
Dec. 27, 2005 (TW) 094146627

(51) Int. Cl. H04M 1/64

(52) U.S. Cl. 379/88.17

(57) ABSTRACT

An electronic player for implementing Internet telephony function and method therefof, wherein the electronic player comprises a connecting interface for establishing connection and communication between said electronics player and a computer; an audio signal controller for transmitting encoded audio signals between said computer and said electronic player according to an audio communication protocol; a central processing unit for handling encoding and decoding of the audio signals, providing digital-to-analog/analog-to-digital conversion, and exchanging audio data with said audio signal controller through said connecting interface; an audio input/output unit for inputting/outputting the audio signals; and a channel switching unit for switching said electronic player between a normal mode and an internet telephone mode, thereby said electronic player can not only work as a music player in a normal mode, but also serve as an internet telephone with call receiving and call dialing capability when connected to a computer in an internet telephone mode.

### FIELD OF THE INVENTION

The present invention relates to an electronic player for implementing internet telephony function and method thereof, more specifically to a method and an electronic player utilizing the existing features of the electronic player to implement an internet telephone.

### BACKGROUND OF THE INVENTION

In general, the cost of the communication via the Internet, compared to the communication via the traditional PSTN (Public Switched Telephone Network) phone, is lower. Currently there are two types of internet phone. One comes with a telephone set, and a user can use it to get directly connection to the internet. However, a user has to purchase accompanying equipments to fully operate the set. And beside the higher cost on the equipments, lack of mobility is also a disadvantage of this type of physical internet phones.

The other type of internet phone obtains internet connection via a computer. The computer is equipped with an audio device or sound card and a headset, plus installed with an internet phone communication software. A user can simply click a button on the user interface of the computer to dial a phone call through the internet. Despite a lower cost, this type of internet phone is inferior to conventional PSTN phones as it's less convenient.

With the growing popularity of internet and sky-rocketing demand of long distance communication, technologies that incorporate the internet protocol in realizing telephone communication (e.g. Voice over Internet Protocol, VOIP) has gained an edge over traditional ones and been embraced by the market. Other widely used internet communication software programs include MSN Messenger and Skype (utilizing P2P technology).

MPEG-1 Audio Layer 3, more commonly referred to as MP3, is a popular digital audio encoding and lossy compression format, designed to greatly reduce the amount of data to as little as 1/10 of the original data required to represent audio, yet still sound like a faithful reproduction of the original uncompressed audio to most listeners. That is why electronic players which play audio files in MP3 format have become extremely popular among music listeners.

To be able to download songs from a computer, an MP3 player usually comes with an Universal Serial Bus (USB) interface. Basing on that concept, a USB audio signal controller can download songs from the computer and store them in the MP3 player, while exchanging audio data with the internet and implementing telephony function on an MP3 player by installing associated communication application program on the computer as well as the support of a bottom layer communication protocol (e.g. H.263).

### SUMMARY OF THE INVENTION

In order to increase the value and functionality of existing MP3 players, after considerable research and experimentation, an electronic player for implementing internet telephony function and method thereof according to the present invention have been developed to overcome the drawbacks associated with the prior art.

The present invention provides an electronic player for implementing Internet telephony function and a method therefore in which an existing audio transmitting/receiving channel and a connecting interface (e.g. USB interface) are employed to communicating with a computer, thereby said electronic player can not only work as a music player, but also serve as an internet telephone with call receiving and call dialing capabilities when connected to a computer.

### BRIEF DESCRIPTION OF THE DRAWINGS

The features, objects and advantages of the invention will become more apparent from the detailed description set forth below when taken in conjunction with the drawings in which like references characters identify correspondingly throughout, and wherein:

FIG. 1 is a representative hardware diagram showing a first preferred embodiment in accordance with the present invention.

FIG. 2 is a representative software diagram showing said first preferred embodiment in accordance with the present invention.

FIG. 3 is a signal flow chart illustrating the procedure of the first preferred embodiment.

### DETAILED DESCRIPTION OF THE PREFERRED EMBODIMENTS

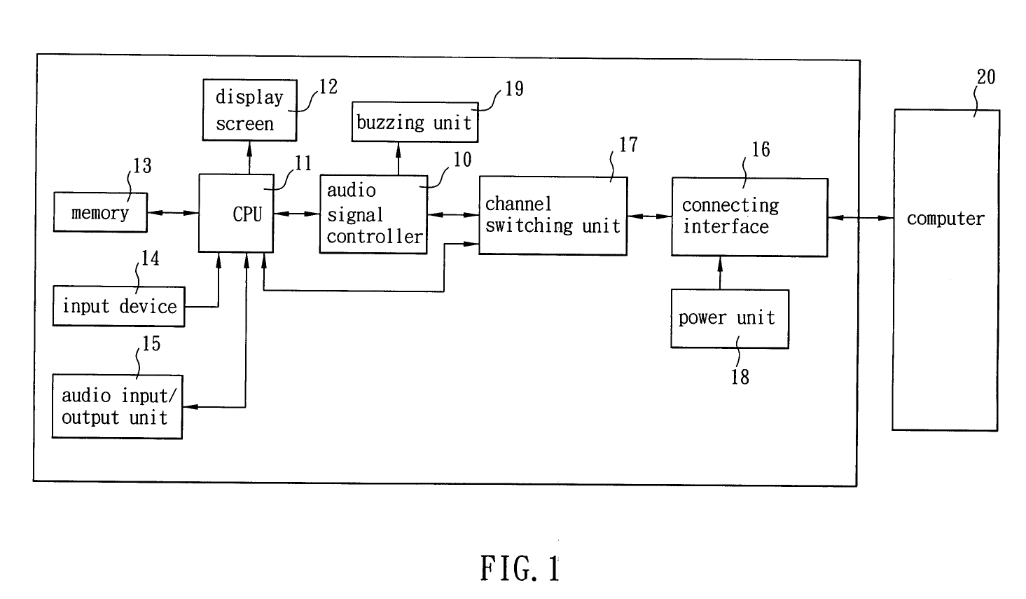

An object of the present invention is to provide an electronic player for implementing internet telephony. Refer to FIG. 1 for the hardware structure of a first preferred embodiment according to the present invention, the electronic player, such as a MP3 player, comprises an audio signal controller 10 (e.g. USB audio signal controller), a central processing unit (CPU) 11, a display screen (e.g. LCD) 12, a memory 13, an input device (e.g. press buttons) 14, an audio input/output unit (e.g. a microphone and earphone) 15, a connecting interface 16 (e.g. USB connecting interface), a channel switching unit 17 (USB channel switching unit), a power unit 18, and a buzzing unit 19. Said audio signal controller 10 is for transmitting encoded audio signals between a computer 20 and said electronic player according an audio communication protocol (e.g. USB audio communication protocol). Said central processing unit 11 handles encoding and decoding of audio signals and provides digital-to-analog and analog-to-digital conversion, and is for exchanging audio data with said audio signal controller 10 through a serial bus (e.g. I2S bus). Said display screen 12 is for displaying information in text or graphics. Said memory 13 is for storing audio encoding and decoding codes and other data related to said MP3 player and said computer 20. Said input device 14 is for accepting commands from a user. Said audio input/output unit 15 is for inputting/outputting audio signals. Said connecting interface 16 is for connection and communication between said MP3 player and said computer 20. Said channel switching unit 17 is for switching said MP3 player between a normal mode and an internet telephone mode. Said power unit 18 comprises a charging circuit for a battery and is the power source which supplies power to all parts in said MP3 player. Said buzzing unit 19 rings upon receiving an incoming call when said MP3 player is in said internet telephone mode.

Consequently, to implement internet telephony function on an MP3 player with an existing connecting interface 16 (e.g. USB connecting interface), the present invention simply includes additional audio signal controller 10 (e.g. USB audio signal controller), channel switching unit 17 (USB channel switching unit), and buzzing unit 19 on said MP3 player. With those additional units, said central processing unit 11 is able to encode and decode audio signals and handle digital-to-analog/analog-to-digital conversion as well as exchange audio data with said audio signal controller 10 through a serial bus.

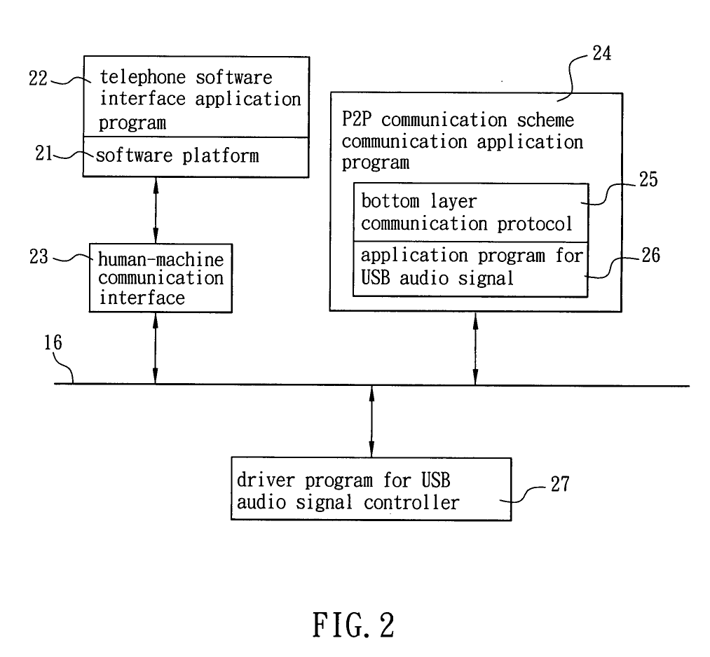

Refer to FIG. 2 for the software structural diagram of said preferred embodiment. Said MP3 player is installed with a software platform 21 and a telephone software interface application program 22. Said telephone software interface application program 22 is developed basing on said platform 21, driven by a human-machine communication interface 23, connected to said computer 20 through said connecting interface 16, and controlled by a driver program 27 of said audio signal controller 10. Said computer 20 is further installed with a communication application program 24 (e.g. Skype) which utilizes a P2P (point-to-point) communication scheme, said scheme incorporates a bottom layer transmission protocol 25 (e.g. H.263) and a USB audio signal application program 26 for handling audio signals.

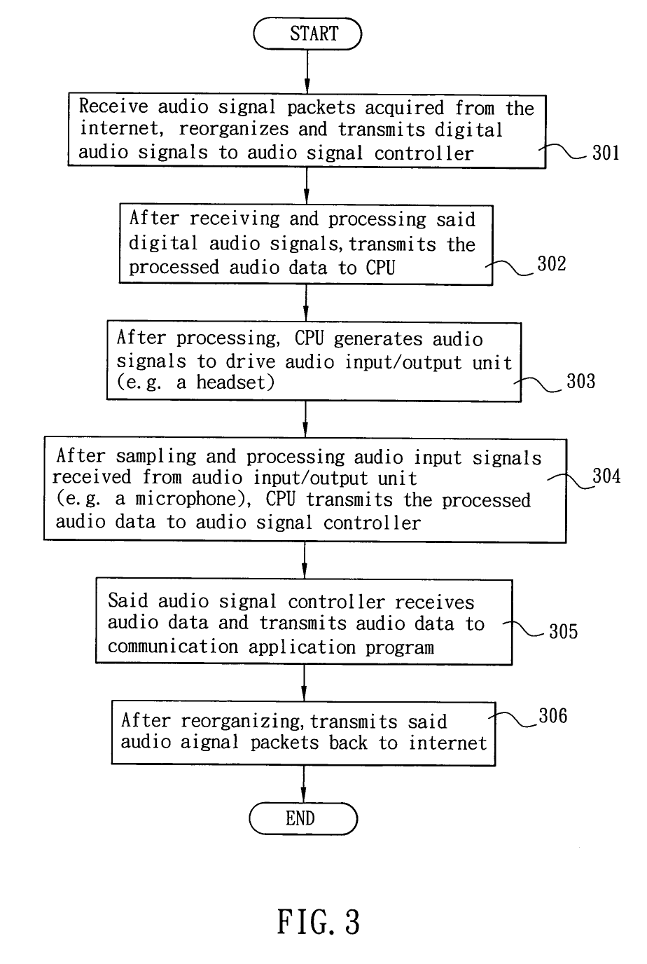

Another object of the present invention is to provide a method for implementing Internet telephony function on said MP3 player. When said MP3 player is connected to said computer 20 through said connecting interface 16 and said communication application program 24 (e.g. Skype) having an internet telephony function is running, the following steps are executed. Refer to FIG. 3.
(301) Said communication application program 24 receives audio signal packets of an internet telephone acquired by said computer 20 from the internet, reorganizes said audio signal packets into digital audio signals and transmits the digital audio signals to said audio signal controller 10 (e.g. USB audio signal controller) through said connecting interface 16 (e.g. USB connecting interface).
(302) After processing the digital audio signals, said audio signal controller 10 transmits the processed audio data to said central processing unit 11 through said serial bus.
(303) After processing said audio data, said central processing unit 11 generates audio signals to drive said audio input/output unit 15 (e.g. a headset). At this time, said audio input/output unit 15 works as a receiver of a telephone.
(304) After sampling and processing audio input signals received from said audio input/output unit 15 (e.g. a microphone), said central processing unit 11 transmits the processed audio data through said serial bus to said audio signal controller 10. This time the audio input/output unit 15 works as a sender of the telephone.
(305) Said audio signal controller 10 receives said audio data sent by said central processing unit 11 and, after processing, transmits said audio data to said communication application program 24 through said connecting interface 16.
(306) After receiving said audio data from said audio signal controller 10, said communication application program 24 reorganizes and converts said audio data into the format of said audio signal packets, transmits said audio signal packets back to the internet to conclude the current internet telephone operation.

In the above-mentioned steps shown in FIG. 3, the audio signals do not have to be received first and then transmitted as depicted in this preferred embodiment. It was so described for the sole purpose of a more understandable explanation. As a matter of fact, the audio signals being received and transmitted in the preferred embodiment are under the coordination of control signals and may happen in any random order with respect to time.

In order to dial a phone call through the internet, said computer 20 is first connected to the internet. Said pre-installed communication application program 24 and the driver program 27 for said audio signal controller 10 are then executed. Said MP3 player and said computer 20 are connected. After said connecting interface is successfully activated, the execution of said communication application program 24 is under detection. Said MP3 player stays in its normal mode if said communication application program 24 is not being executed. Once said communication application program 24 is detected to be running, said channel switching unit 17 (e.g. USB channel switching unit) will be turned on and switched to said audio signal controller 10. Now said MP3 player changes said normal mode to the internet telephone mode, displays corresponding user interface on said display screen 12, and shows a message to indicate the current working mode (i.e. internet telephone mode) and a graphical telephone interface. Through said input device 14 (e.g. buttons), a user can click to input his/her selection of function or numbers. Accordingly, said MP3 player operates as a telephone set.

When making an internet telephone call, a user selects or dials a number by pressing the digit buttons on said graphical telephone interface. After being entered by the user, the number is transmitted to said audio signal controller 10 by said central processing unit 11. That information is then passed on through said connecting interface 16 to said communication application program 24 and subsequently to the internet to make an attempt at connecting to a receiving end of the call. The status of the call can be indicated by the messages provided from the internet (e.g. dialing/receiving end busy/connected/disconnected). When it shows that the receiving end has been successfully connected, the user is then able to talk to the receiving end with the audio input/output unit 15 (e.g. a microphone and speakers or a headset). If the receiving end is busy, the user has to hang up and re-dial the call later. The volume is also conveniently adjustable.

When said MP3 player operates under the internet telephone mode and there's an incoming call, said buzzing unit 19 rings in response to that event. The user can decide whether to take that phone call by checking the caller ID shown on the display screen 12.

The present invention and therefore the preferred embodiment take advantage of the existing connecting interface 16 (e.g. USB connecting interface) on said MP3 player to connect and establish a communication channel with said computer 20 so that audio signal packets are transmitted through said connecting interface 16 to said audio signal controller 10. After said central processing unit 11 encoding and decoding the audio signals and providing digital-to-analog and analog-to-digital conversion, audio signals are generated to drive said audio input/output unit 15(e.g. a headset). The audio inputlout unit 15 behaves as a receiving channel at this time. On the other hand, said audio input/output unit 15 (e.g. a microphone) also works to receive voice signals from a user. Said voice signals are processed by said central processing unit 11, transmitted to said audio signal controller 10, and transmitted to said computer 20 through said connecting interface 16 and finally to said internet through said computer 20. This time, said audio input/output unit 15 becomes a transmitting channel. As described, said audio input/output unit 15 is capable of multitasking between a receiving channel and a transmitting channel, therefore an internet telephony function is implemented on said MP3 player.

While the invention herein disclosed has been described by means of specific embodiments, numerous modifications and variations could be made thereto by those skilled in the art without departing from the scope and spirit of the invention set forth in the claims.

What is claimed is:

1. A method for implementing Internet telephony function on an electronic player, said method comprising the steps of:
connecting with a computer on-line with the internet via a connecting interface;
when said computer executes a communication application program corresponding to said electronic player, establishing an audio transmitting/receiving channel with said computer;
switching the mode of said electronic player into an internet telephone mode; receiving a plurality of audio signal packets acquired by said computer from the internet; and
receiving voice signals from a user, and then transmitting said voice signals to said communication application program via said connecting interface.

2. The method of claim 1 wherein, before switching into the internet telephone mode, the mode of said electronic player is in a normal mode working as a music player.

3. The method of claim 1, wherein said audio transmitting/receiving channel transmits and receives signals through a universal serial bus (USB).

4. The method of claim 1, wherein said electronic player comprises a buzzing unit, and said buzzing unit rings when said electronic player receives an incoming call and is in said internet telephone mode.

5. The method of claim 1, wherein said communication application program utilizes a peer-to-peer (P2P) communication scheme including a bottom layer transmission protocol and another application program for handling the audio signals.

6. The method of claim 5, wherein said another application program for handling the audio signals is a USB audio signal application program.

7. The method of claim 1, wherein said connecting interface is a USB connecting interface.

8. The method of claim 1, wherein said electronic player is for playing files in a plurality of multimedia formats.

9. The method of claim 1, wherein said electronic player is a MP3 player.

10. An electronic player for implementing Internet telephony function, said electronic player comprising:
a connecting interface for establishing connection and communication between said electronics player and a computer;
an audio signal controller for transmitting encoded audio signals between said computer and said electronic player according to an audio communication protocol stored therein;
a central processing unit for handling encoding and decoding of the audio signals, providing digital-to-analog/analog-to-digital conversion, and exchanging audio data with said audio signal controller through said connecting interface;
an audio input/output unit for inputting/outputting the audio signals; and
a channel switching unit for switching said electronic player between a normal mode and an internet telephone mode.

11. The electronic player of claim 10, wherein said electronic player is installed with a software platform and a telephone software interface application program, and said telephone software interface application program is developed basing on said platform, driven by a human-machine communication interface, connected to said computer through said connecting interface, and controlled by a driver program of said audio signal controller.

12. The electronic player of claim 11, wherein said audio input/output unit includes a microphone and a headset.

13. The electronic player of claim 10, wherein said electronic player is for playing a file in a compressed audio format.

14. The electronic player of claim 10, wherein said electronic player is a MP3 player.

15. The electronic player of claim 10, wherein said audio signal controller is a USB audio signal controller and said audio communication protocol is a USB audio communication protocol.

16. The electronic player of claim 10, wherein said connecting interface is a USB connecting interface.

17. The electronic player of claim 10, wherein said channel switching unit is a USB channel switching unit.

18. The electronic player of claim 10, wherein said electronic player comprises a buzzing unit, and said buzzing unit rings when said electronic player receives an incoming call and is in said internet telephone mode.
